(19) United States
(12) Patent Application Publication
(10) Pub. No.: US 2010/0116682 A1
(43) Pub. Date: May 13, 2010

(54) ELECTROCHEMICAL SENSOR WITH INTERDIGITATED MICROELECTRODES AND CONDUCTED POLYMER

(75) Inventors: Pavel Neuzil, Singapore (SG); Hsiao-Hua Yu, Singapore (SG); Jackie Y. Ying, Singapore (SG)

Correspondence Address: WOLF GREENFIELD & SACKS, P.C., 600 ATLANTIC AVENUE, BOSTON, MA, 02210-2206, US

(73) Assignee: AGENCY FOR SCIENCE, TECHNOLOGY AND RESEARCH, Centros (SG)

(21) Appl. No.: 12/310,957

(22) PCT Filed: Sep. 13, 2007
(86) PCT No.: PCT/US2007/019848

§ 371 Date: Dec. 30, 2009

Related U.S. Application Data
(60) Provisional application No. 60/844,572, filed on Sep. 14, 2006.

(51) Int. Cl. G01N 27/26; C25B 3/00; G01N 27/403

(52) U.S. Cl. 205/419; 204/400; 205/414; 205/775

(57) ABSTRACT

The present invention generally relates to electronic devices and methods. In some cases, the invention provides a sensor device comprising a pair of interdigitated microelectrodes (60), coated with an electrically conducting polymer material (70). The microelectrodes (60) may be surrounded by a first electrode (22), a second electrode (40), and a hydrophobic wall (50).

### FIELD OF THE INVENTION

The present invention related to electronic devices and related methods including polymerization methods and sensing methods.

### BACKGROUND OF THE INVENTION

Electronic devices employing organic conducting materials, including conducting polymers such as side-chain and/or main-chain functionalized polythiophenes, have been studied. In some cases, such devices have been employed as sensors. For example, previous work involved the modulation of drain current between two sets of interdigitated electrodes by varying the oxidation state of a conducting polymer positioned in contact with electrodes. Upon exposure to a solution of target analyte, the amperometric response based on resistivity differences was observed.

Fabrication of such sensors often includes deposition the organic conductive material onto the electrodes by electropolymerization of a monomeric species to form a conducting polymer film. However, known procedures for electropolymerization and/or detection often require large volumes of monomer and/or analyte solutions, as well as large surface areas, which can increase the cost and challenges in developing new sensor materials. In addition, reproducibility of the data was difficult and often was highly dependent on the electrochemical cell configuration adopted in different experimental setups.

Accordingly, improved methods are needed.

### SUMMARY OF THE INVENTION

The present invention relates to electronic devices comprising at least two interdigitated microelectrodes, each of the interdigitated microelectrodes being in contact with an electrically-conducting polymer material, which electrically-conducting polymer material forms a polymeric structure providing a conductive pathway between the at least two interdigitated microelectrodes; a first electrode essentially completely circumscribing the at least two interdigitated microelectrodes a second electrode essentially completely circumscribing the first electrode; and a hydrophobic material circumscribing the second electrode. In some embodiments, the electrically-conducting polymer is selected from the group consisting of polyaniline, polythiophene, polypyrrole, polyphenylene, polyarylene, poly(bisthiophene phenylene), poly(arylene vinylene), poly(arylene ethynylene), and organic and transition metal derivatives thereof. In some embodiments, the first electrode and the second electrode have complementary shapes. For example, in some cases, the first electrode and the second electrode are each substantially circular structures.

The present invention also relates to electronic devices comprising at least two interdigitated microelectrodes, each of interdigitated microelectrodes being in contact with an electrically-conducting polymer material, which electrically-conducting polymer material forms a polymeric structure providing a conductive pathway between the at least two interdigitated microelectrodes; and a hydrophobic material circumscribing the at least two interdigitated microelectrodes.

Another aspect of the present invention provides polymerization methods comprising contacting less than 50 μL of a solution comprising a monomeric species with a first electrode and a second electrode, wherein the monomeric species comprises at least two functional groups that, in the presence of electrical potential, allow the monomeric species to form an electrically-conducting polymer; applying an electrical potential to at least one of the first electrode and the second electrode; and

polymerizing the monomeric species to form an electrically-conducting . polymer.

The present invention also provides methods for determining an analyte comprising exposing less than 50 μL of a sample suspected of containing an analyte to at least two interdigitated microelectrodes comprising an electrically-conducting polymer material forming a polymeric structure, wherein the polymeric, structure has a conductivity; and determining the analyte by-detecting a change in the conductivity of the polymeric structure subsequent to the exposing step.

The present invention also relates to electronic devices comprising an interdigitated structure of at least, two microelectrodes; a first electrode essentially completely circumscribing the interdigitated structure; and a second electrode essentially completely circumscribing the first electrode. In some embodiments, the electronic devices may further comprise a hydrophobic material circumscribing the second electrode. In some embodiments, the first electrode and the second electrode have complementary shapes. For example, in some cases, the first electrode and the second electrode are each substantially circular structures.

The present invention also relates to electronic devices comprising an electrically insulating substrate; a first electrically conducting layer having first and second opposed surfaces disposed on a surface of the substrate so that the first surface of the first electrically conducting layer overlays and is in contact with at least a portion of the surface of the substrate; an electrically insulating layer having first and second opposed surfaces disposed on the second surface of the first electrically conducting layer so that the first surface of the electrically insulating layer overlays and is in contact with selected portions of the second surface of the first electrically conducting layer and does not overlay other portions of the second surface of the first electrically conducting layer, which other portions of the second surface of the first electrically conducting layer form at least one electrode; and a second electrically conducting layer having first and second opposed surfaces disposed on the second surface of the electrically insulating layer so that the first surface of the second electrically conducting layer overlays and is in contact with selected portions of the electrically insulating layer and does not overlay other portions of the second surface of the electrically insulating layer, wherein the second electrically conducting layer forms at least two electrodes comprising an interdigitated microelectrode array.

### BRIEF DESCRIPTION OF THE DRAWINGS

FIG 1A. shows a top-view of an electronic device, according to one embodiment of the invention.

FIG. 1B shows a cross-sectional view of an electronic device, according to brie embodiment of the invention.

FIG. 2 shows a top-view of a chip having four individual electronic devices.

FIG. 3 shows a photograph of a fabricated chip containing four individual electronic sensors, wherein each electronic sensor is capable of confining a sample volume of 4 microliters within a hydrophilic area having a 3 mm-diameter.

FIGS. 4A-D show cross-sectional views of various steps in the fabrication of an electronic device, according to one embodiment of the invention.

FIG. 5 shows the cyclic voltammogram of one 5 microliter drop of ferrocene in 0.1 M nBu₄NPF₆ and propylene carbonate upon application of an electrical potential using an electronic device according to one embodiment of the invention.

FIG. 6 shows the cyclic voltammogram of one 5 microliter of a 10 mM solution of bithiophene in 0.1 M nBut₄NPF₆ and propylene carbonate upon application of an electrical potential using an electronic device according to one embodiment of the invention. The arrow indicates the progression of electropolymerization of bithiophene with time.

FIG. 7 shows the cyclic voltammogram of a poly(bithiophene) film prepared from application of a 5 microliter drop of a bithiophene solution in 0.1 M nBu₄NPF₆ and propylene carbonate to an electronic device according to one embodiment of the invention.

### DETAILED DESCRIPTION

The present invention generally relates to electronic devices and methods. In some cases, devices of the invention may be constructed to accommodate samples having small volumes (e.g., less than 50 microliters). Devices of the invention may also be configured to enhance performance by, for example, facilitating symmetric diffusion of charge or formation of a more uniform electric field. In some cases, the present invention provides devices having a simplified configuration. In some cases, devices of the invention may employ the use of organic material in, for example, sensing devices and methods. Other methods of the invention relate to polymerization methods. One advantage of the present invention includes the ability to work with small amounts (e.g., volumes) of a sample using a simplified electronic device without the need to for more complex microfluidic devices, for example.

Electronic devices of the invention may comprises the use of electrode (e.g., working electrodes) in combination with various other components, such as organic materials and/or other materials or components, configured to optimize the performance of the device. For example, devices of the invention may comprise a component selected and arranged to facilitate the use of small volumes of sample. In some cases, devices of the invention may comprise electrodes having a particular shape and arrangement with respect to one another that may enhance device performance by, for example, enabling more efficient diffusion between electrodes.

In some embodiments, the present invention may involve the symmetrical configuration of various components, such as electrodes. Since many electrochemical processes are controlled by diffusion, a symmetrical arrangement of certain electrodes may facilitate the symmetric diffusion of electroactive species within the device, leading to enhanced performance of the devices. In some cases, an electronic device, of the invention may comprise at least two working electrodes (e.g., cathode, anode), a first electrode essentially completely circumscribing the interdigitated structure, and a second electrode essentially completely circumscribing the first electrode. In some cases, the first electrode and the second electrode have complementary shapes. For example, in some cases, me first electrode and me second electrode are each substantially circular structures. Other electrode shapes are also possible, such as square, rectangular, oval, triangular, and the like.

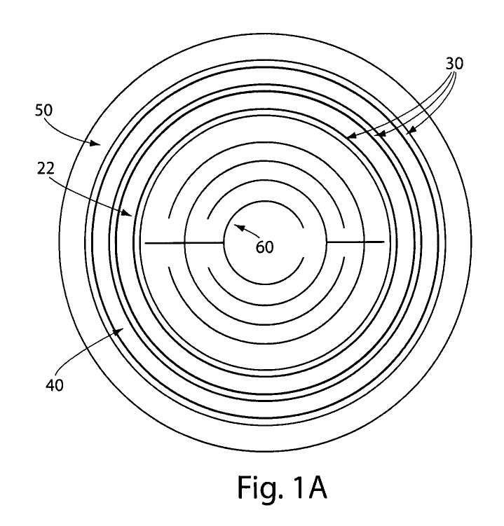

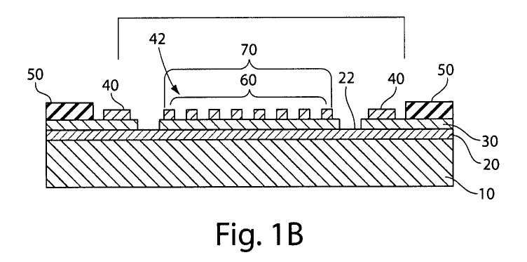

As used here, the term “essentially completely circumscribing” refers to the formation of a closed perimeter around an object, wherein the object may not necessarily be surrounded in three dimensions, but may be at least enclosed by the perimeter when viewed from above, i.e., such that the object and the perimeter are projected onto the same plane. For example, FIG. 1A shows a top-view of an electronic device, wherein electrode 22 and electrode 40 form concentric circular structures circumscribing the electrodes 60. In some cases, each of the electrodes may lie within the same physical plane. In other cases, each of the electrodes may lie within different parallel physical planes and the term “essentially completely circumscribing” refers to the relative positioning of electrodes when projected onto a single plane. For example, as shown in FIG. 1A, electrode 22 may lie in a first plane and electrode 40 may lie in a second plane; wherein the first plane is paralleled to and positioned below the second plane. However, electrode 40 “essentially completely circumscribes” electrode 22 because, when projected onto a single plane, electrode 40 forms a closed perimeter around electrode 22.

In some cases, the electrodes may preferably be positioned in nearly the same physical plane, that is, the distance between parallel planes may be small relative to the dimensions of the outer electrode (e.g., electrode 40 in FIG. 1A). As an illustrative embodiment, a circular, outer electrode having a diameter may be positioned in a different parallel plane than an inner electrode, wherein the ratio of the distance between parallel planes and the diameter of the outer electrode is 1:10, 1:100, 1:250, 1:500, 1:1000, 1:2500, 1:5000, 1:10,000, or greater.

In some cases, the working electrodes may be an interdigitated structure of at least two microelectrodes. An interdigitated microelectrode configuration, which can provide rapid response, low impedance, allowing for simple detection of impedance changes, e.g. via high current changes at constant voltage. As used herein, the term “interdigitated electrodes” or “interdigitated microelectrodes” indicates at least two complementarily-shaped electrodes, wherein “branches” or “fingers” of each electrode are disposed in an alternating fashion. For example, as shown in FIG. 1A, interdigitated electrodes 60 contain curved “branches” which are arranged in an alternating fashion with respect to one another. It should be understood that other shapes of electrodes may also be suitable for use as interdigitated electrode. For example, a pair of comb-shaped electrodes may be used, wherein the “fingers” of each electrode ace positioned in an alternating-fashion. In some cases, a pair of interdigitated electrodes may be used as the working electrodes in devices of the invention.

Devices of the invention may further comprise a material selected and configured to contain a fluid sample (e.g., droplet) within a particular area of the device. The material may be configured to surround an area comprising the electroactive components and may be selected to contain a particular type of fluid sample in that area. For example, a hydrophobic material may be selected to contain a sample comprising a hydrophilic solution, such as an aqueous solution, an organic solution, or mixture thereof. This allows the use of small volumes (e.g., less than 50 microliters) of a sample, which, in some cases, may be dispensed directly onto a surface of the device via a micropipette, for example. In some cases, the hydrophobic material (e.g., Teflon) may have a water contact angle greater than 90 degrees, or greater than 120 degrees, and the area comprising the electroactive components may be a hydrophilic surface having a water contact angle of less than, for example, 90 degrees. Examples of hydrophobic materials include perfluorocarbon-based materials, such as Teflon. Those of ordinary skill in the art would be able to select appropriate materials that would be suitable for use in containing a particular sample.

In an illustrative embodiment shown in FIG. 1A, device 100 comprises a set of interdigitated electrodes 60, and an electrode 22 essentially completely circumscribing the interdigitated electrodes 60. A second electrode 40 essentially completely surrounds electrode 22. As shown in FIG. 1A a hydrophobic material 50 surrounds the electrode structure such that a fluid sample may contact the electroactive components of the device. In some cased, it may also be advantageous that some electrodes of the invention may be continuous structures, that is, the shape of the electrodes are not interrupted by a space to provide room for electrical leads.

In some embodiments, devices of the invention may also comprise an electrically-conducting polymer material in contact with the at least two interdigitated microelectrodes, wherein the electrically-conducting polymer material forms a polymeric structure providing a conductive pathway between the at least two interdigitated microelectrodes. Typically, the electrically-conducting polymer material may comprise an extensive intertwined array of individual conducting pathways, wherein each individual pathway is provided by a polymer chain or a nanoscopic aggregate of polymer chains. In some cases, the electrically-conducting polymer material may be used as a sensing material, as described more fully below. FIG. 1B shows an electrically-conducting polymer material 70 formed as a film in contact with the interdigitated electrodes 60 (e.g., working electrodes).

In some embodiments, the present invention provides the ability selectively coat portions of a device with a material, such as an organic material, rather than indiscriminately coating various portions of a device. In one embodiment, a film of an electrically-conducting polymer material may be formed selectively on the surface of the working electrodes and not on, for example, the reference-electrode, the counter electrode, various portions comprising insulating materials, or other components of the device.

In one embodiment, an electronic device of the invention may comprise at least two interdigitated microelectrodes, each of the interdigitated microelectrodes being in contact with an electrically-conducting polymer material, which electrically conducting polymer material forms a polymer structure providing a conductive pathway between the at least two interdigitated microelectrodes, and a hydrophobic material circumscribing the at least two interdigitated microelectrodes.

Another advantage of the present invention comprises the use of a layered or “sandwich” structure of electrodes. For example, a structure may comprise various electrode material layers, insulating layers, or other layers positioned in a stacked configuration, wherein the layers are in contact with one another. In one embodiment, an insulating layer may be positioned between and in contact with two electrode layers, which may produce a more uniform electric field. In some cases, some layers may be patterned using various lithography methods, such that an area of an underlying layer may be exposed through an opening in an overlying layer. In one embodiment, an electrode may be defined by ah area of an electrode material layer that is exposed through an opening in an insulating layer positioned above the electrode material layer. Such an arrangement may advantageously allow for the formation of continuously-shaped electrodes, such as a substantially circular electrode.

In one embodiment, the device may comprise an electrically insulating substrate, and a first electrically conducting layer having first and second opposed surfaces disposed on the surface of the substrate so that the first surface of the first electrically conducting layer overlays and is in contact with at least a portion of the surface of the substrate. The device may further comprise an electrically insulating layer having first and second opposed surfaces disposed on the second surface of the first electrically conducting layer, so that the: first surface of the electrically insulating layer overlays and is in contact with selected portions of the second surface of the first electrically conducting layer and does not overlay other portions of the second surface of the first electrically conducting layer, which other portions of the second surface of the first electrically conducting layer form at least one electrode. The device may further comprise a second electrically conducting layer having first and second opposed surfaces disposed on the second surface of the electrically insulating layer, so that the first surface of the second electrically conducting layer overlays and is in contact with selected portions of the electrically insulating layer and does not overlay other portions of the second surface of the electrically insulating layer, wherein the second electrically conducting layer forms at least two electrodes comprising an interdigitated microelectrode array.

In the illustrative embodiment shown in FIG. 1B, electrically conducting layer 20 is disposed on a surface of substrate 10 such that electrically conducting layer 20 is in contact with at least a portion of the surface of substrate 10. Electrically insulating layer 30 is disposed on electrically conducting layer 20 such that electrically insulating layer 30 overlays and is in contact with selected portions of electrically conducting layer 20, and does not overlay other portions of electrically conducting layer 20. For example, electrically insulating layer 30 does not overlay portion 22 of electrically conducting layer 20, such that portion 22 forms at least one electrode, such as a reference or counter electrode. Electrically conducting layer 42 may comprise electrically conducting components 60 (e.g., interdigitated electrodes), which may be disposed on selected portions of electrically insulating layer 30 and does not overlay other portions of electrically insulating layer 30, such that electrically conducting layer 60 forms at least two electrodes comprising an interdigitated microelectrode array. Electrically conducting layer 42 may also comprise electrode 40, which may be a counter or reference electrode. The device may also comprise a hydrophobic material 50, as described herein. The device may optionally comprise a conducting polymer material layer 70, as described herein. Simple lithography methods may be used to pattern electrically insulating layer 30 and/or electrically conducting layer 42. A top-view of the device is also shown in FIG. 1A. In this arrangement, a more uniform electrical film may be formed due to the ability to form electrodes, such as counter and/or reference electrodes, which essentially completely surround the working electrodes (e.g., interdigitated electrodes). For example, the electric field formed and the diffusion of charge may be more symmetrical relative to previous systems.

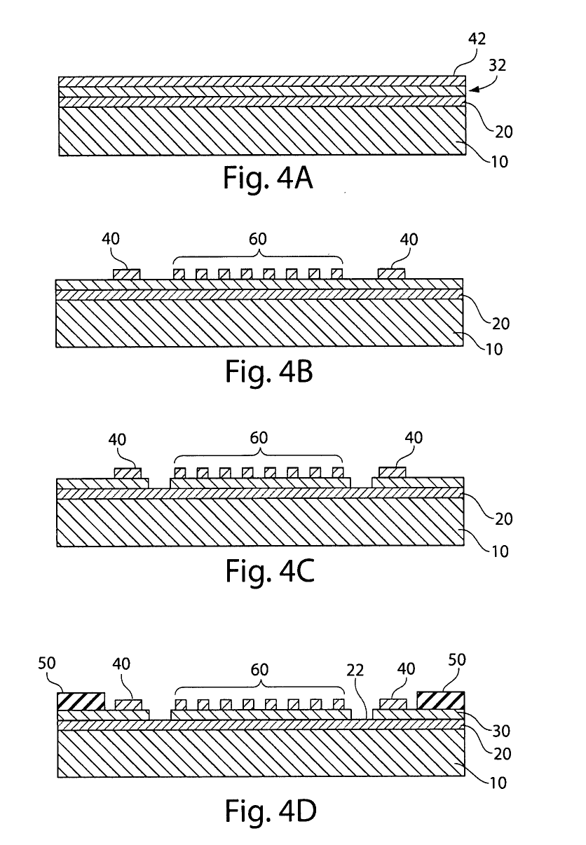

Methods for fabricating such devices may include the use of chemical vapor deposition (e.g., plasma-enhanced chemical vapor deposition); lithography (e.g., photolithography), and the like. For example, FIGS. 4A-D show cross-sectional views of various steps in the fabrication of an electronic device having a layered structure as described herein. As shown in FIG. 4A, a layered-structure may be formed comprising an electrically conducting layer 20 formed on a surface of substrate 10, an insulating layer 32 formed on a surface of electrically conducting layer 20, and an electrically conducting layer 42 formed on a surface of insulating layer 32. Electrically conducting layer 42 may be patterned via, for example, photolithography to form a circular electrode 40 and a pair of interdigitated electrodes 60 (FIG. 4B). Insulating layer 32 may likewise be patterned to expose a circular portion 22 of underlying electrically conducting layer 20, wherein portion 22 serves as an electrode (FIG 4B). As shown in FIG. 4D, a hydrophobic material 50 may be formed around me electrode configuration to define an area comprising the electroactive elements of the device.

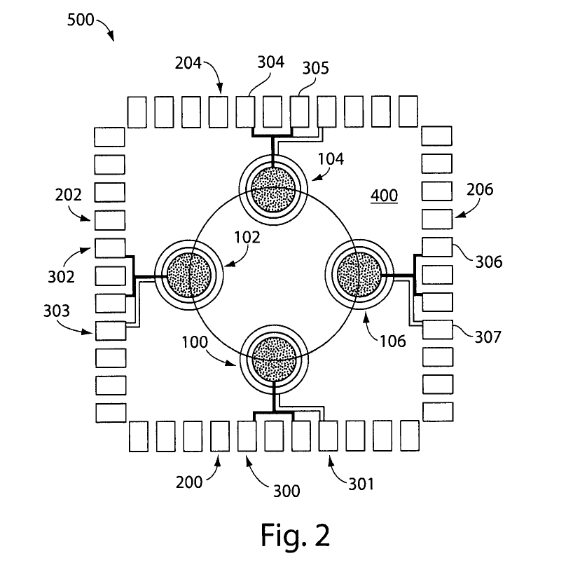

In some embodiments, devices of the invention may also comprise multiple electrode configurations, as described herein, within a single device. For example, as shown in FIG. 2, device 500 comprises four individual electrode structures, as shown by structures 100, 102, 104 and 106, wherein each electrode structure may optionally comprise working electrodes, counter and reference electrodes, conducting polymer material, or materials for containing a fluid sample. The structures may be positioned on a hydrophobic surface 400. Contacts 200, 202, 204, 206, 300, 301, 302, 303, 304, 305, 306 and 307 may provide various electrical contacts for the electrodes. It should be understood that devices of the invention may comprise any number of electrode structures on a single device, as desired to suit a particular application.

In some cases, the devices of the invention may advantageously accommodate sample sizes having a volume of less than 50 microliters. In some cases, the device may accommodate a sample size having a volume of 0.1-50 microliters, or more, preferably, 1-10 microliters, or, more preferably, 1-5 microliters. It should be understood that samples having volumes greater than 50 microliters may also be used within the scope of the invention. In some cases, if the volume of the sample is particularly small (e.g., 0.1 microliters), the sample may be optionally combined with a material to prevent evaporation of the sample. For example, oil may be combined with or used to “cover” a sample that is aqueous, organic, or a mixture thereof. The samples (e.g., droplets) may be delivered to the device via a micropipette of other methods.

Another aspect of the present invention provides methods for polymerization. In one embodiment, the method comprises contacting less than 50 microliters of a solution comprising a monomeric species with a first electrode and a second electrode, wherein the monomeric species comprises at least two functional groups that, in the presence of electrical potential, allow the monomeric species to form ah electrically-conducting polymer. Application of an electrical potential to at least one of the first electrode and the second electrode and polymerization of the monomeric species may then form an electrically-conducting polymer. In some cases, the electrically-conducting polymer may be deposited on the surface of the electrodes as a film. In some cases, the electrically-conducting polymer may remain in solution. In other cases, the electrically-conducting polymer may first be deposited on the surface of the electrodes as a film and then be dissolved into solution.

In one embodiment, the polymerization occurs by electropolymerization, i.e. by the application of a defined electrochemical potential. At this potential, the monomer may undergo radical formation via reduction or oxidation (i.e., an electrochemical redox reaction), wherein recombination of the radicals can produce oligomers, which may subsequently be reduced or oxidized and combined with other radical oligomers or monomers. In other embodiments, a monomer may comprise a first site of polymerization and a second site of polymerization, wherein sequential polymerization can be effected by subjecting the monomer to a first electrochemical potential at which the first site undergoes an electrochemical redox reaction. The first electrochemical potential may not be sufficiently large to initiate a reduction or oxidation reaction at the second site of polymerization. Upon completion of the first polymerization, the monomer may then be subjected to a greater electrochemical potential sufficient to cause a reduction or oxidation reaction at the second site. Other examples of this polymerization can be found in Marsella et al, J. Am. Chem. Soc., Vol. 116, p. 9346-8 (1994) and Marsella et al., J. Am. Chem. Soc., Vol. 117, p. 9832-9841 (1995), each of which is incorporated herein by reference in its entirety.

Examples of monomeric species suitable for use in the invention include pyrrole, aniline, thiophene, bithiophene, 3,4-ethylenedioxythiophene, and substituted derivatives thereof.

Polymerization methods as described herein may be conducted in the presence of various electrolytes, as known to those of ordinary skill in the art. As used herein, an “electrolyte” is given its ordinary meaning in the art and refers to a substance which may operate as an electrically conductive medium. The electrolyte can comprise any material capable of transporting either positively or negatively charged ions or both between two electrodes and should be chemically compatible with the electrodes. An example of an electrolyte is [(n-Bu)₄N]PF₆.

Other electropolymerization conditions, such as solvent, electrochemical potential, and the like, may be described in, for example, Kittlesen, et al., J. Am. Chem. Soc. 1984, 106, 7389; S. S. Zhu, T. M. Swager, Adv. Mater. 1996, 8, 497; S. S. Zhu, T. M. Swager, J. Am. Chem. Soc. 1996, 118, 8713; S. S. Zhu, T. M. Swager, J. Am. Chem. Soc. 1997, 119, 12568; P. L. Vidal, M. Billon, B. Divisia-Blohorn, G. Bidan, J. M. Kern, J. -P. Sauvage, Chem. Commun. 1998, 629, each of which is incorporated herein by reference in its entirety.

The present invention also provides methods for determining of an analyte. As used herein, the term “determining” generally refers to the analysis of a species or signal, for example, quantitatively or qualitatively, and/or the detection of the presence or absence of the species or signals; “Determining” may also refer to the analysis of an interaction between two or more species or signals, for example, quantitatively or qualitatively, and/or by detecting the presence or absence of the interaction. For example, a sample having a volume less than 50 μL and suspected of containing an analyte may be exposed to at least two interdigitated microelectrodes comprising a polymeric structure as described herein. The analyte may interact with the polymeric structure to cause a change in the conductivity of the polymeric structure, wherein the change in the conductivity may then determine the analyte.

In some embodiments, the interaction between the analyte and the polymeric structure may comprise formation of a bond, such as a covalent bond (e.g. carbon-carbon, carbon-oxygen, oxygen-silicon, sulfur-sulfur, phosphorus-nitrogen, carbon-nitrogen, metal-oxygen or other covalent bonds), an ionic bond, a hydrogen bond (e.g., between hydroxyl, amine, carboxyl, thiol and/or similar functional groups, for example), a dative bond (e.g. complexation or chelation between metal ions monodentate or multidentate ligands), or the like. The interaction may also comprise Van der Waals interactions. In one embodiment, the interaction comprises forming a covalent bond with an analyte. The polymeric structure may also interact with an analyte via a binding event between pairs of biological molecules. For example, the polymeric structure may comprise an entity, such as biotin that specifically binds to a complementary entity, such as avidin or streptavidin, on a target analyte.

The analyte may be a chemical or biological analyte. The term “analyte,” may refer to any chemical, biochemical, or biological entity (e.g. a molecule) to be analyzed. In some cases, the polymeric structure may be selected to have high specificity for the analyte, and may be a chemical, biological, or explosives sensor, for example. In some embodiments, the analyte comprises a functional group that is capable of interacting with at least a portion of the polymeric structure. For example, the functional group may interact with the outer layer of the article by forming a bond, such as a covalent bond. In some cases, the polymeric structure may determine changes in pH, moisture, temperature, or the like.

Using methods as described herein, devices of the invention may be used as sensors, such as electrochemical amperometric or conductometric sensors. The devices may be used to perform conductivity, measurements or other electrochemical measurements. Other potential applications include use as an electrochemical cell for performing characterization and application of, for example, a conducting polymer film deposited on the surface of the device. In some cases, devices of the invention may be reusable. For example, in sensing devices, the binding constant of a target analyte to the device may determine the ability to regenerate and/or reuse the device. Upon binding, the analyte may be removed by applying heat or solvents. In some cases, the device may be autoclaved. In other embodiments, the device may be disposable.

The electrically-conducting polymer may be any polymer capable of conducting electron density along the backbone of the polymer. As used herein, an “electrically-conducting polymer” or “conducting polymer” refers to any polymer having a conjugated pi-backbone capable of conducting electronic charge. Typically, atoms directly participating in the conjugation form essentially a plane, wherein the plane may arise from a preferred arrangement of p-orbitals to maximize p-orbital overlap, thus maximizing conjugation and electronic conduction. In some embodiments, the electron derealization may also extend to adjacent polymer molecules. In some cases, at least a portion of the conducting polymer comprises a multi-dentate ligand. In some cases, the further, comprising a metal atom bonded to a portion of the conducting polymer. For example, the conducting polymer may comprise a metal atom, such as a transition metal, lanthanide, or actinide.

In some cases, at least a portion of the conducting polymer may comprise a functional group that acts as a binding site for an analyte. The binding site may comprise a biological or a chemical molecule able to bind to another biological or chemical molecule in a medium, e.g. in solution. For example, the binding site may be a functional group, such as a thiol, aldehyde, ester, carboxylic acid, hydroxyl, or the like, wherein the functional group forms a bond with the analyte. In some cases, the binding site may be an electron-rich or electron-poor moiety within the polymer, wherein interaction between the analyte and the conducting polymer comprises an electrostatic interaction.

The binding site may also be capable of biologically binding an analyte via an interaction that occurs between pairs of biological molecules including proteins, nucleic acids, glycoproteins, carbohydrates, hormones, and the like. Specific examples include an antibody/peptide pair, an antibody/antigen pair, an antibody fragment/antigen pair, an antibody/antigen fragment pair, an antibody fragment/antigen fragment pair, an antibody/hapten pair, an enzyme/substrate pair, an enzyme/inhibitor pair, an enzyme/cofactor pair, a protein/substrate pair, a nucleic acid/nucleic acid pair, a protein/nucleic acid pair, a peptide/peptide pair, a protein/protein pair, a small molecule/protein pair, a glutathione/GST pair, an anti-GFP/GFP fusion protein pair, a Myc/Max pair, a maltose/maltose binding protein pair, a carbohydrate/protein pair, a carbohydrate derivative/protein pair; a metal binding, tag/metal/chelate, a peptide tag/metal ion-metal chelate pair, a peptide/NTA pair, a lectin/carbohydrate pair, a receptor/hormone pair, a receptor/effector pair, a complementary nucleic acid/nucleic acid pair, a ligand/cell surface receptor pair, a virus/ligand pair, a Protein A/antibody pair, a Protein G/antibody pair, a Protein L/antibody pair, an Fc receptor/antibody pair, a biotin/avidin pair, a biotin/streptavidin pair, a drug/target pair, a zinc finger/nucleic acid pair, a small molecule/peptide pair, a small molecule/protein pair, a small molecule/target pair, a carbohydrate/protein pair such as maltose/MBP (maltose binding protein), a small molecule/target pair, or a metal ion/chelating agent pair. In some cases, devices and related methods of the invention may be used in applications such as drug discovery the isolation or purification of certain compounds, or high-throughput screening techniques.

Examples of electrically-conducting polymers include, but are not limited to, polyaniline, polythiophene, poly(3,4-ethylenedioxy)thiophene, polypyrrole, polyphenylene, polyarylene, poly(bisthiophene phenylene), poly(arylene vinylene), poly(arylene ethynylene), a conjugated ladder polymer (i.e. a polymer which requires the breaking of at least two bonds to break the chain), polyiptycene, polytriphenylene, substituted derivatives thereof, and transition metal derivatives thereof. In some cases polythiophene and substituted derivatives thereof are preferred.

The electrodes may be any material capable of conducting charge. Examples of materials suitable for use as electrodes include metals or metal-containing species such as gold, silver, platinum, or indium tin oxide (ITO). In some cases, gold or silver is preferred. The electrode structures may be. formed by various deposition techniques, such as chemical vapor deposition, plasma-enhanced chemical vapor deposition, and the like. In some cases, the electrode structures may have a thickness of 100 microns or less, 50 microns or less, or, more preferably, 20 microns or less, 10 microns or less, 5 microns or less, 2 microns or less, or 1 micron or less.

In some embodiments, insulating materials can be positioned between active elements of the device (e.g., electrodes). The insulating material may he any-material that does not conduct charge upon application of an electrochemical potential and may be used to reduce or prevent direct contact between electrodes. In some cases, it may be preferred for the insulating material to be chemically inert to the electrode materials. Examples of materials suitable for use as insulating materials may include nitrides, such as SiN, oxides, carbides, and the like. In some embodiments, the insulating material is SiN.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily-appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features systems, articles, materials, kits, and/or methods, if such features, systems, articles materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the- specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., die inclusion of at least one, but also including more than one, of a number of list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”“Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally he present other.: than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one; optionally including more than one, A with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

### EXAMPLES

### Example 1

### Sensor Fabrication

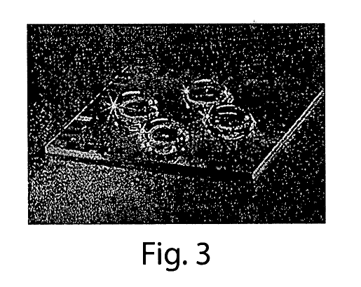

An electronic device was fabricated with components haying a circular geometry for droplet-based electropolymerization and sensor applications, symmetrical reference and counter electrodes for electric field uniformity, and a perfluorocarbon-based hydrophobic material to confine both water- and organic-based droplet formation. FIG. 3 shows a photograph of a device containing four individual electronic sensors, wherein each electronic sensor is capable of confining a sample volume of 4 microliters within a hydrophilic area having a 3 mm-diameter. The device can be applied towards developing novel conductive materials and resistivity-based sensors.

Pyrex 7740 wafers with a diameter; of 4″ were used as the substrates. After cleaning in piranha solution, a chrome layer having 10 nm-thickness and a silver layer having 500 nm-thickness were deposited by e-beam evaporation. The silver layer was covered by a 1 μm-thick film of low-stress silicon nitride deposited by plasma-enhanced chemical vapor deposition (PECVD). A chrome layer of 10 nm-thick and a gold layer of 250 nm-thick were then deposited by e-beam evaporation. Photolithography was performed using AZ 7220 positive photoresist with a thickness of 2 μm to define the working and counter electrodes, as well as the electrode lead-outs. A gold/chrome sandwich was then patterned by backsputtering in Unaxis-LLS 100 Physical Vapor Deposition (PVD) system (200 W). After photoresist removal and wafer cleaning, a second lithography was performed and nitride-etched by SF₆ plasma so as to define me silver electrode and the silver soldering pad opening. A second nitride layer of 0.5 μm was deposited by PECVD to protect and electrically isolate the gold electrodes. Subsequently, a fluorocarbon polymer layer was deposited by the inductively coupled plasma system (Alcatel) with C₄F₈ gas for 30 sec (20 mTorr, 2000 W). The Teflon-like layer achieved has a thickness of 100 nm and a water contact angle of 120°. A third lithography step was performed to open all bonding pads and the defined areas in the electrochemical cell. Oxygen plasma (2000 W) was applied for 30 sec to remove the fluorocarbon layer, without significantly affecting the photoresist layer. The last step involved silicon nitride etching with SF₆ plasma for 30 seconds, and photoresist removal by acetone.

The fabricated chips were tested at wafer lever for shorts and leakage current between all electrodes using the Cascade probe station with Agilent 4156C Semiconductor Parameter Analyzer. Each wafer was then diced; into individual chips by diamond dicing saw, and soldered to a printed circuit board (PCB) using a custom-made soldering system. After soldering, the chips were tested again for shorts.

### Example 2

### Sensor Testing

The sensor device was designed for two functions: (1) conducting electropolymerization and material deposition on selected electrode surface from one droplet (e.g., <10 μL) of monomer solution of conjugated compound, including pyrrole, aniline, thiophene, bithiophene, ethylenedioxythiophene, and their derivatives, and (2) as an electrochemical cell for characterization, testing and application of the as-deposited materials from one droplet of solution (e.g., <10 μL). The device having a perfluorocarbon surface coating may be used for droplets of both aqueous and non-aqueous solutions.

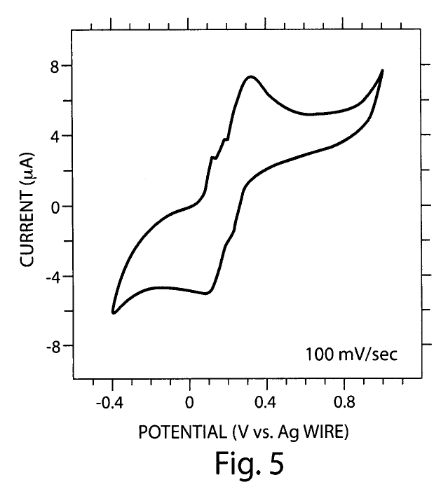

First, cyclovoltammograms of ferrocene (in organic solution) and ferricyanide (in aqueous solution) were measured to test the system. The cyclic voltammogram of one droplet (5 μL) of ferrocene solution in propylene carbonate in the presence of 0.1 M nBU₄NPF₆ is shown in FIG. 5. A reversible wave with half-wave potential (E^{1/2}) at 0.2 V was observed. The device employed Ag wire as the reference electrode, and, thus, there was a 0.2 V shift compared to the more popular Ag/Ag⁺ references electrode (E^{1/2} of ferrocene=0 V). The half-wave potential of 0.2 V from ferrocene in propylene carbonate solution demonstrated the good performance of Ag reference electrode.

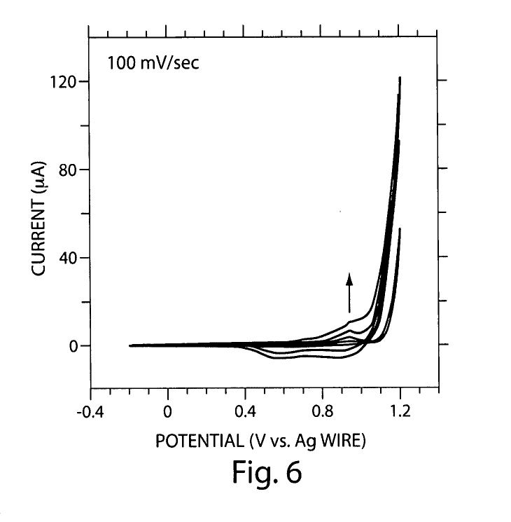

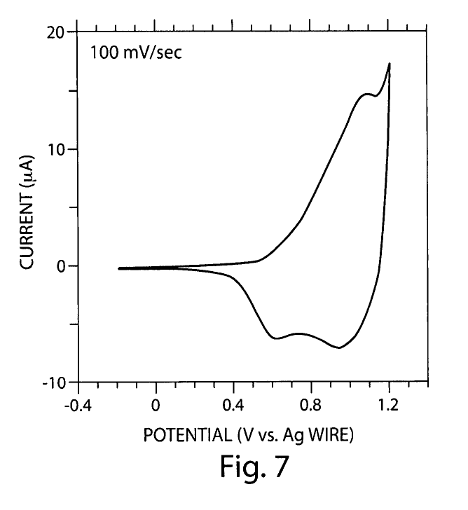

To validate the device performance, a bithiophene monomer was electropolymerized between the working electrodes to form a polymer film. One droplet of a 0.1 M nBu₄PF₆/propylene carbonate solution containing 10 mM of bithiophene monomer was deposited on the area of the device containing the active electrodes. Upon application of electrochemical potential to the droplet, growth of red poly(bithiophene) film on the surface of the working electrodes was observed. As shown in FIG. 6, increasing the current upon repeated cycling indicated that the electropolymerization took place on the surface of the electrode. After rinsing the device several times with propylene carbonate, the cyclic voltammogram was measured for one droplet (5 μL) of monomer-free, 0.1 M nBu₄PF₆/propylene carbonate solution. As shown in FIG. 7, the cyclic voltammogram was almost identical to that obtained using the conventional three-electrode system. This confirmed the capability of the fabricated miniaturized device for sensor testing.

What is claimed:

1. An electronic device, comprising:
at least two interdigitated microelectrodes, each of the interdigitated microelectrodes being in contact with an electrically-conducting polymer material, which electrically-conducting polymer material forms a polymeric structure providing a conductive pathway between the at least two interdigitated microelectrodes,
a first electrode essentially completely circumscribing the at least two interdigitated microelectrodes;
a second electrode essentially completely circumscribing the first electrode and
a hydrophobic material circumscribing the second electrode.

2. An electronic device as in claim 1, wherein the electrically-conducting polymer is selected from the group consisting of polyaniline, polythiophene, polypyrrole, polyphenylene, polyarylene, poly(bisthiophene phenylene), poly(arylene vinylene), poly(arylene ethynylene), and organic and transition metal derivatives thereof.

3. An electronic device as in claim 1, wherein the first electrode and the second electrode have complementary shapes.

4. An electronic device as in claim 1, wherein the first electrode and the second electrode are each substantially circular structures.

5. An electronic device as in claim 1, wherein the at least two interdigitated microelectrodes, the first electrode, and the second electrode each independently comprise gold, silver, platinum, or indium tin oxide (ITO).

6. An electronic device as in claim 1, wherein the hydrophobic material is Teflon.

7. An electronic device as in claim 1, wherein the at least two interdigitated microelectrodes, the first electrode, and the second electrode are positioned within an area having a diameter of 10 mm or less.

8. An electronic device as in claim 1, wherein the at least two interdigitated microelectrodes, the first electrode, and the second electrode are positioned within an area having a diameter of 5 mm or less.

9. An electronic device as in claim 1, wherein the at least two interdigitated microelectrodes, the first electrode, and the second electrode are positioned within an area having a diameter of 3 mm or less.

10. An electronic device, comprising:
at least two interdigitated microelectrodes, each of the interdigitated microelectrodes being in contact with an electrically-conducting polymer material, which electrically-conducting polymer material forms a polymeric structure providing a conductive pathway between the at least two interdigitated microelectrodes; and
a hydrophobic material circumscribing the at least two interdigitated microelectrodes.

11. An electronic device as in claim 10, wherein the electrically-conducting polymer is selected from the group consisting of polyaniline, polythiophene, polypyrrole, polyphenylene, polyarylene, poly(bisthiophene phenylene), poly(arylene vinylene), poly(arylene ethynylene), and organic and transition metal derivatives thereof.

12. An electronic device as in claim 10, wherein the at least two interdigitated microelectrodes comprise gold, silver, platinum, or indium tin oxide (ITO).

13. An electronic device as in claim 10, wherein the hydrophobic material is Teflon.

14. An electronic device as in claim 10, wherein the at least two interdigitated microelectrodes are positioned within an area having a diameter of 10 mm of less.

15. An electronic device as in claim 10, wherein the at least two interdigitated microelectrodes are positioned within an area having a diameter of 5 mm or less.

16. An electronic device as in claim 10, wherein the at least two interdigitated microelectrodes are positioned within an area having a diameter of 3 mm or less.

17. A polymerization method, comprising:
contacting less than 50 μL of a solution comprising a monomeric-species with a first electrode and a second electrode, wherein the monomeric species comprises at least two functional groups that, in the presence of electrical potential, allow the monomeric species to form an electrically-conducting polymer;
applying an electrical potential to at least one of the first electrode and the second electrode; and
polymerizing the monomeric species to form an electrically-conducting polymer.

18. A polymerization method, as in claim: 17, comprising contacting less than 10 microliters of the solution comprising the monomeric species with the first electrode and the second electrode.

19. A polymerization method as in claim 17, comprising contacting less than 5 microliters of the solution comprising the monomeric species with the first electrode and the second electrode.

20. A polymerization method as in claim 17, comprising contacting less than 1 microliter of the solution comprising the monomeric species with the first electrode and the second electrode.

21. A polymerization method as in claim 17, wherein the monomeric species is pyrrole, aniline, thiophene, bithiophene, 3,4-ethylenedioxythiophene, or substituted derivatives thereof.

22. A polymerization method as in claim 17, wherein the electrically-conducting polymer is selected from the group consisting of polyaniline, polythiophene, polypyrrole, polyphenylene, polyarylene, poly(bisthiophene phenylene), poly(arylene vinylene), poly(arylene ethynylene), and organic and transition metal derivatives thereof.

23. A method for determining an analyte comprising:
exposing less than 50 μL of a sample suspected of containing an analyte to at least two interdigitated microelectrodes comprising an electrically-conducting polymer material forming a polymeric structure, wherein the polymeric structure has a conductivity; and
determining the analyte by detecting a change in the conductivity of the polymeric structure subsequent to the exposing step.

24. A method as in claim 23, comprising exposing less than 10 microliters of the sample suspected of containing an analyte to the at least two interdigitated microelectrodes comprising the electrically-conducting polymer material forming the polymeric structure.

25. A method as in claim 23, comprising exposing less than 5 microliters of the sample suspected of containing an analyte to the at least two interdigitated microelectrodes comprising the electrically-conducting polymer material forming the polymeric structure.

26. A method as in claim 23, comprising exposing less than 1 microliters of the sample suspected of containing an analyte to the at least two interdigitated microelectrodes comprising the electrically-conducting polymer material forming the polymeric structure.

27. A method as in claim 23, wherein the electrically-conducting polymer is selected from the group consisting of polyaniline, polythiophene, polypyrrole, polyphenylene, polyarylene, poly(bisthiophene phenylene), poly(arylene vinylene), poly(arylene ethynylene), and organic and transition metal derivatives thereof.

28. An electronic device, comprising:
an interdigitated structure of at least two microelectrodes;
a first electrode essentially completely circumscribing the interdigitated structure; and a second electrode essentially completely circumscribing the first electrode.

29. An electronic device as in claim 28, further comprising a hydrophobic material circumscribing the second electrode.

30. An electronic device as in claim 28, wherein the first electrode and the second electrode have complementary shapes.

31. An electronic device as in claim 28, wherein the first electrode and the second electrode are each substantially circular structures.

32. An electronic device as in claim 28., wherein the at least two interdigitated microelectrodes, the first electrode, and the second electrode each independently comprise gold, silver, platinum, or indium tin oxide (ITO).

33. An electronic device, comprising:
an electrically insulating substrate;
a first electrically conducting layer having first and second, opposed surfaces disposed on a surface of the substrate so that the first surface of the first electrically conducting layer overlays and is in contact with at least a portion of the surface of the substrate;
an electrically insulating layer having first and second opposed surfaces disposed on the second surface of the first electrically conducting layer so that the first surface of the electrically insulating layer overlays and is in, contact with selected portions of the second surface of the first electrically conducting layer and does not overlay other portions of the second surface of the first electrically conducting layer, which other portions of the second surface of the first electrically conducting layer form at least one electrode; and
a second electrically conducting layer having first and second opposed surfaces disposed on the second surface of the electrically insulating layer go that the first surface of the second electrically conducting layer overlays and is in contact with selected portions of the electrically insulating layer and does not overlay other portions of the second surface of the electrically insulating layer, wherein the second electrically conducting layer forms at least two electrodes comprising an interdigitated microelectrode array.

34. An electronic device as in claim 33, wherein the first electrically conducting layer and the second electrically conducting layer each independently comprise gold, silver, platinum, or indium tin oxide (ITO).

35. An electronic device as in claim 33, wherein the electrically insulating layer is SiN.
